(19) United States
(12) Patent Application Publication
(10) Pub. No.: US 2002/0087413 A1
(43) Pub. Date: Jul. 4, 2002

(54) Vending machine adapted to vend age-restricted items

(75) Inventors: Kevin E. Mahaffy, Victorville, CA (US); David B. Mahaffy, Fresno, CA (US); Eric E. Schmidt, Hesperia, CA (US)

Correspondence Address: David P. Gordon, Esq., 65 Woods End Road, Stamford, CT, 06905, US

(73) Assignee: agent AI, Inc.

(21) Appl. No.: 10/061,731

(22) Filed: Feb. 1, 2002

Related U.S. Application Data
(63) Continuation-in-part of application No. 09/657,719, filed on Sep. 8, 2000.

(51) Int. Cl. G06F 17/60

(52) U.S. Cl. 705/16

(57) ABSTRACT

A vending machine includes a video camera for transmitting an image of a buyer to a remotely located human operator, a document reader for transmitting an image of identification document(s) to the remotely located human in control of the vending machine, and a user interface which gives the appearance that the machine is autonomous even though the operator's approval is required prior to vending an age-restricted item. The machine also includes a payment acceptor and a dispensing apparatus.

This application is a continuation-in-part of U.S. Ser. No. 09/657,719, filed Sep. 8, 2000, entitled “A Point-Of-Sale Commercial Transaction Processing System Using Artificial Intelligence Assisted By Human Intervention”, the complete disclosure of which is hereby incorporated by reference herein.

### BACKGROUND OF THE INVENTION

1. Field of the Invention

The invention relates to vending machines. More particularly, the invention relates to a vending machine which is adapted to vend age-restricted items.

2. State of the Art

Most vending machines have a simple mechanical interface through which the vending machine is operated locally by the purchaser. One of the most widely known type of these vending machines is the soft drink vending machine. The interface for a soft drink vending machine consists of a currency acceptance mechanism (coin slot and/or bill slot), a series of push buttons, a beverage dispenser, and a coin return. These machines are autonomous and do not depend on a remote location for normal operations. Some newer vending machines may include an apparatus for communicating with a remote location to signal that inventory is low, but they are still autonomous in normal operation.

Some vending machines allow for payment with a credit/debit card. These machines do not act autonomously. They must communicate with a remote location in order to process a transaction. Credit/debit card accepting vending machines include ATM machines (which vend cash), airline ticket vending machines, parking lot/garage payment machines, etc. These machines generally include a more sophisticated interface than a soft drink vending machine. They usually include a card reader, a video display for displaying text or a combination of text and graphics and a keypad for entering data. The keypad may be integrated into a touch-responsive display. The display is used to prompt the user for input which is entered via the keypad. The data obtained from the keypad as well as from the card reader is transmitted to a remote location where it is verified by a computer before the transaction can be completed. Although the transaction requires communication with a remote location, the transaction is effected automatically without human intervention (other than that of the purchaser). The impersonal nature of this transaction may be considered an advantage in some situations.

U.S. Pat. No. 4,845,636 to Walker discloses a remote transaction system which may be used to conduct business transactions wherein visual contact between a buyer and a seller is desired or required. The Walker system provides two-way audio and video communication between a purchaser and a human representative of the seller so that the seller can observe the buyer prior to completing the transaction. The Walker system also includes a document reader so that the buyer can provide a documentary form of identification for the seller's representative to examine prior to authorizing the transaction. According to Walker, his system is particularly useful for transactions which require face-to-face communication between the buyer and the seller. The sole example given by Walker of such a transaction is where a rental car business must be able to observe a potential user in order to assess the apparent capability of the user to operate the automobile. As such, the Walker system is intended to provide a similar human interaction to that which would otherwise occur during a face-to-face transaction at a car rental counter.

It is imaginable by the inventors hereof that there are many other types of possible vending machine transactions which would require a more definite identification of the buyer than is possible with the conventional ATM-type interface. For example, vending of alcoholic beverages or tobacco should require a verification of the buyer's age. Other types of transactions might include the sale of certain types of over-the-counter medication and other age-restricted products where it is necessary or desired to accurately verify the buyer's age. This is not entirely possible with an ATM-type interface for several reasons. First, present databases for credit/debit cards do not typically provide for age verification. Second, even if age could be linked to a credit/debit account, an overly permissive parent might give a card and password to an unsupervised child and avoid detection. The Walker-type interface could satisfy the requirements of vending which requires age verification. However, the Walker-type interface presents a somewhat more personal interface than other vending machine interfaces. In particular, the buyer is keenly aware that his face and identification document(s) are being verified by a human being who the buyer can see in a video display. Moreover, the Walker-type interface is not likely to increase product sales, as it is not designed for spontaneous purchases.

The inventors hereof believe that it would be advantageous to provide a vending machine of such novelty that it would increase product sales. Moreover, the vending machine should be particularly adapted to vend age-restricted products. One potential manner to create the desired novelty and to verify the age of a purchaser of age-restricted products would be to use a vending machine capable of using artificial intelligence in a manner sufficient to accurately verify the age of a purchaser in order to approve or deny the purchase of such items. However, such technology is not presently available.

### SUMMARY OF THE INVENTION

It is therefore an object of the invention to provide a vending machine particularly adapted to vend age-restricted items.

It is also an object of the invention to provide a vending machine which is apparently autonomous.

It is another object of the invention to provide a vending machine which is adapted to increase sales through its novelty and function.

It is still another object of the invention to provide a vending machine system in which a human being makes the final decision as to whether to authorize a sale of an age-restricted item to a potential buyer of the item.

In accord with these objects which will be discussed in detail below, the vending machine according to the invention includes a video camera for transmitting an image of a buyer to a human remotely-located in a service center and in communication with the vending machine, and a document reader for transmitting an image of identification document(s) to the remotely-located human in control of the vending machine. The vending machine also includes a user interface which gives the appearance that the machine is autonomous, a payment acceptor, and dispensing apparatus.

According to the presently preferred embodiment, the user interface includes a preferably computer-generated animation of a character (“virtual character”), a speech synthesizer (or a library of prerecorded synthetic sounding speech), and a user input which includes a keypad and/or a microphone and voice recognition software. Artificial intelligence software is provided to complete as much of the transaction as possible before the remotely-located human intervenes. However, before any age-restricted item is dispensed to the buyer, the remotely-located human must approve the purchase. Approval includes verifying the validity of the purchaser's identification document, the age of the purchaser, and optionally the sobriety of the purchaser.

In addition, a camera is preferably provided to record the item dispensed and the image is associated with an image of the identification document.

In the interface using the virtual character, the character may advantageously be programmed to interact with the buyer in an entertaining manner, such as a friendly bartender or a brand mascot (e.g., the Budweiser frogs).

Additional objects and advantages of the invention will become apparent to those skilled in the art upon reference to the detailed description taken in conjunction with the provided figures.

### BRIEF DESCRIPTION OF THE DRAWINGS

FIG. 1 is a simplified block diagram illustrating a network of vending machines coupled to a remotely-located service center having a plurality of work stations;

FIG. 2 is a side elevation of a first exemplary vending machine according to the invention;

FIG. 3 is a simplified block diagram of the components of a vending machine according to the invention;

FIG. 4 is a simplified diagram of one of the remote control work stations;

FIG. 5 is a simplified flowchart illustrating the processing of a vending machine transaction according to the invention;

FIG. 6 is a simplified flowchart illustrating the role of remote human control in the processing of a transaction;

FIG. 7 is a first exemplary vending machine for dispensing alcoholic beverages;

FIG. 8 is a second exemplary vending machine for dispensing tobacco products; and

FIG. 9 is a third exemplary vending machine for dispensing a variety of products, some of which do not require intervention of remote human control.

### DETAILED DESCRIPTION OF THE PREFERRED EMBODIMENTS

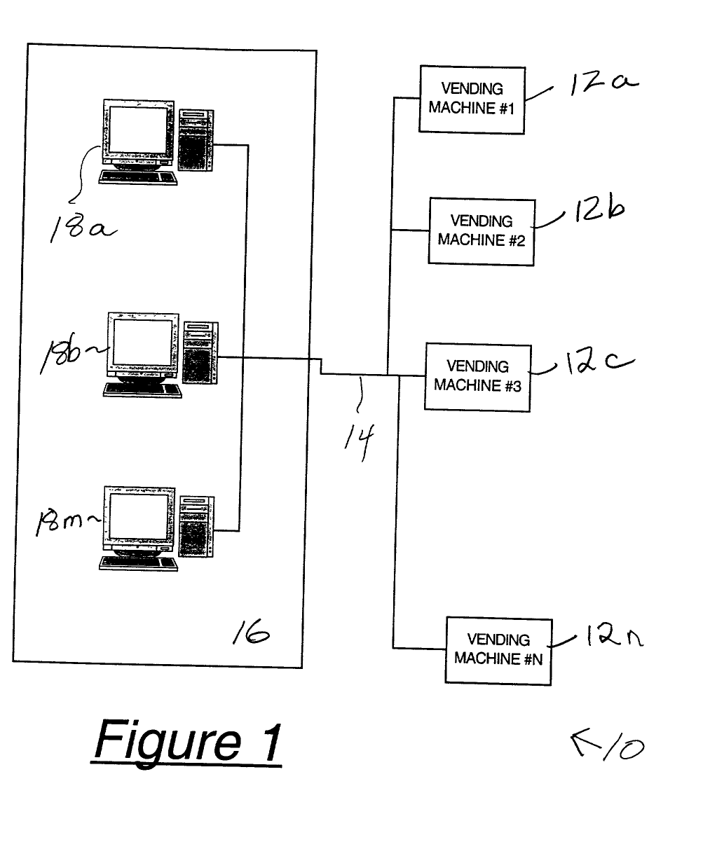

Referring now to FIG. 1, a vending machine network 10 according to the invention includes a plurality of vending machines 12a, 12b, 12c, . . . , 12n coupled via a communications network 14 to a remotely-located service center 16. The service center 16 includes a plurality of work stations 18a, 18b, . . . , 18m each manned by a human worker. Each work station is preferably capable of communicating with all of the vending machines on the network 14. The network connection 14 between the vending machines and the service center is preferably in Internet Protocol (IP) and over either the Internet or a private network.

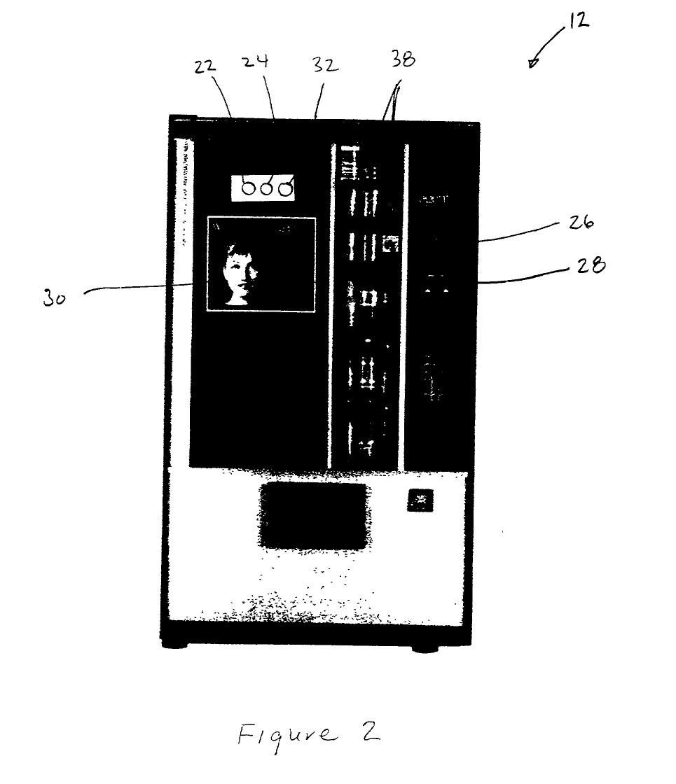

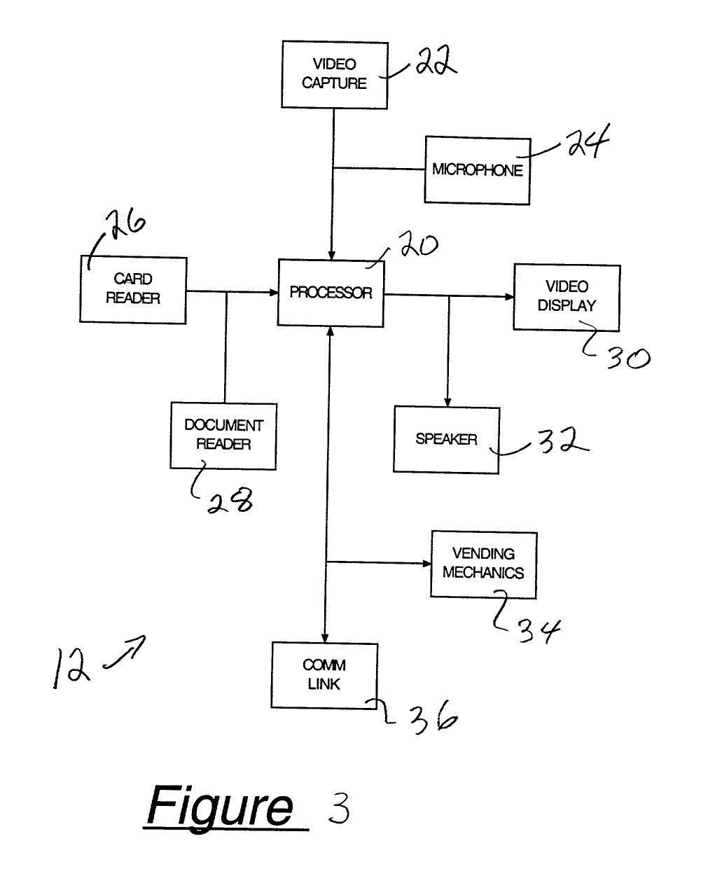

As described in more detail below with reference to FIGS. 2 and 3, an important feature of the invention is that the vending machines include video capture devices for capturing images of the buyer and the buyer's driver's license. However, the communications link between the vending machines and the service center does not need to be very broad band because image data acquired by the vending machines only need be compressed still images, not streaming video. However, if a broadband link is readily and economically available, streaming video of the buyer will provide additional information which can be used by the human in deciding whether to approve a transaction, as discussed below.

Turning now to FIGS. 2 and 3, a vending machine 12 according to the invention includes a processor 20 which receives input from a video capture device 22 for capturing an image of the buyer and optionally a microphone 24 for voice recognition processing of the vending transaction. The processor 20 also receives input from a card reader 26 (and/or a currency reader) for accepting payment and a document reader 28 for capturing a video image of a driver's license or other form of identification. The processor 20 provides output to a video display 30 and a speaker 32 which present the buyer with an “artificial intelligence” interface to the vending machine. The interface preferably includes an animated character on the video display, such as a friendly bartender or a brand mascot (e.g., the Budweiser frogs). The vending machine also appears to a buyer to operate entirely autonomously under “artificial intelligence”. The processor 20 communicates bidirectionally with the vending machine mechanics 34 (e.g. dispensing solenoids, card insertion sensors, etc.) and with the communications link 36 for communicating with the service center. The vending machine 12 is adapted to store and vend age-restricted items 38.

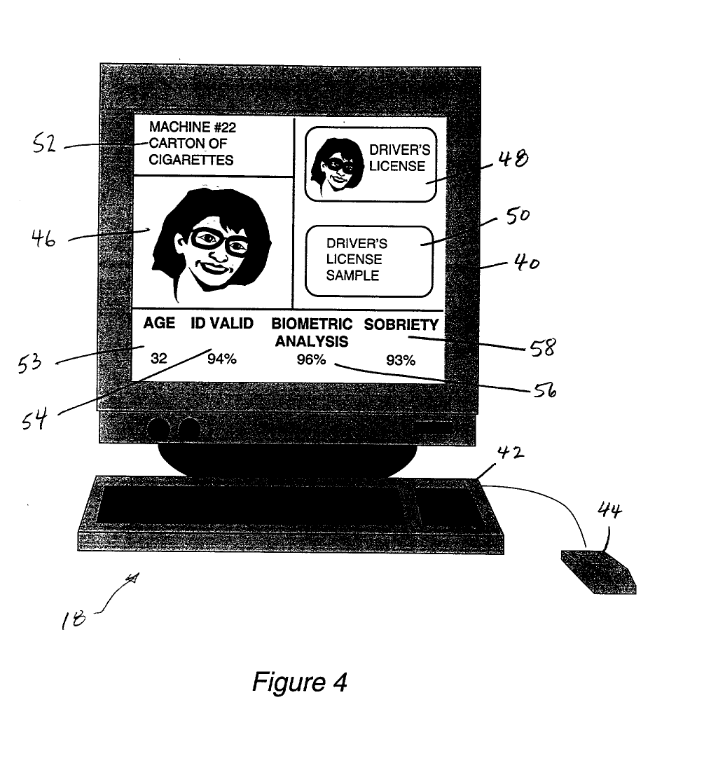

An exemplary service center work station 18 is illustrated in FIG. 4. The work station 18 preferably includes a video display and one or more-input devices, e.g. keyboard 42 and mouse 44. According to the invention, the video display 40 is divided into fields for displaying different information. For example, one field 46 displays a picture of the buyer as captured by the video capture device 26 in the vending machine 12. Another field 48 preferably displays an image of the buyer's driver's license or other photoidentification as captured by the document reader 28 in the vending machine. According to a presently preferred embodiment, the display 40 also includes a field 50 for displaying an image of an exemplary valid driver's license or other photoidentification from the same jurisdiction as indicated by the buyer's driver's license. The display also includes a field 53 for displaying the purported age of the buyer, a field 54 for displaying a percentage probability that the buyer's photoidentification is valid, a field 56 for displaying a percentage probability that the buyer is the person shown in the photoidentification; i.e,. a biometric analysis validity percentage, and a field 58 for displaying a percentage probability that the buyer is sober. Field 53, 54, 56 and 58 are discussed further below. Optionally, the display includes an information field 52 for displaying information such as the identification of the vending machine and the nature of the transaction.

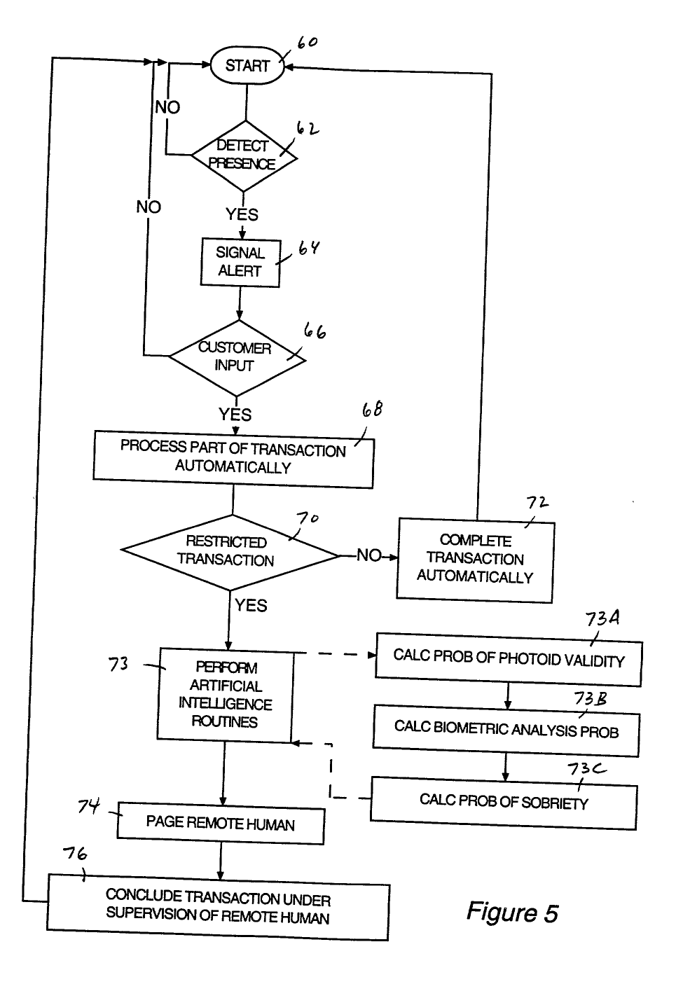

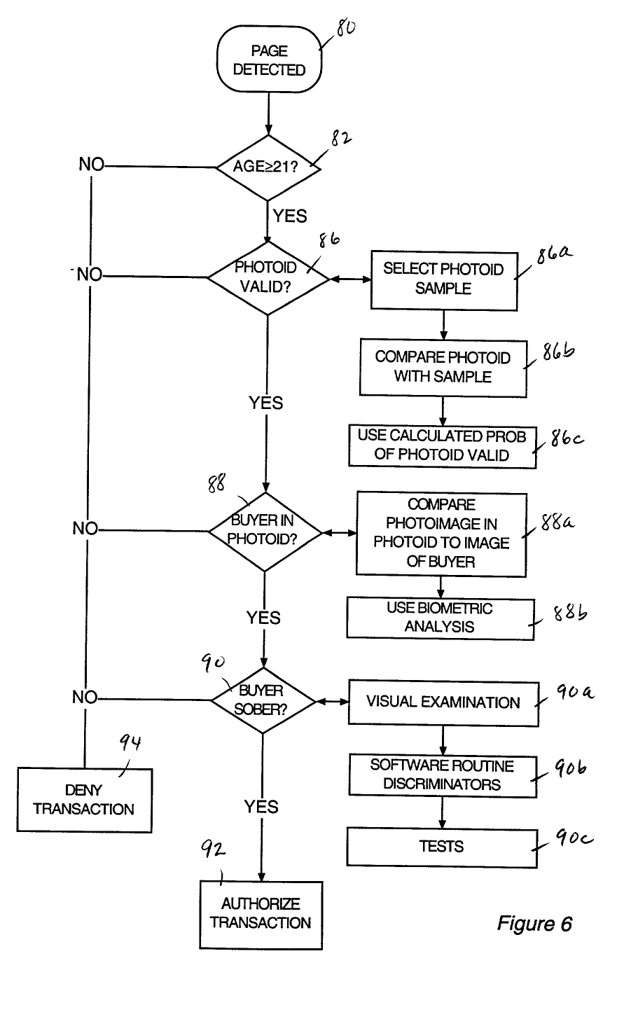

FIG. 5 illustrates the general sequence of operations in a vending machine according to the invention. According to the presently preferred embodiment, starting at 60, the vending machine detects (either via the video capture device or a motion detector) when a prospective purchaser is near the machine at 62. If someone is in the vicinity, the vending machine signals an alert at 64. The alert is preferably a synthesized voice message advertising goods which may be purchased through the vending machine or which otherwise attempt to engage a potential purchaser. For example, in the case of a beverage vending machine, the voice message might be “Hello, would you like a cold drink?” The alert may be any other message which operates to increase the novelty of the device and increase sales. As such, the alert may be a humorous message not even related to the items in the vending machine but which nevertheless operate to gain and retain the attention of a potential purchaser. If customer input is detected at 66, by detecting a customer response, most of the transaction is processed autonomously at 68. For example, the customer selects the item for purchase and tenders payment in either cash or credit/debit card in response to prompts from the vending machine. If a credit/debit card was tendered, the vending machine will validate the card using the normal methods of communicating with a card center. If the item(s) selected for purchase require proof of age, the vending machine will prompt the buyer to insert a driver's license (or similar form of photoidentification) into the document reader 28. The vending machine will pre-authorize the transaction if the payment method has been approved and if the proof of age has been produced if required. If the payment method was not authorized or required proof of age was not tendered, the vending machine will automatically deny the transaction. Preferably, a synthesized voice message will be played. For example, “I'm sorry but your credit card is expired.” or “I'm sorry, the transaction you have chosen requires proof of age.” If the transaction does not require proof of age as determined at 70 in FIG. 5, the vending machine completes the transaction at 72 without human intervention from the remote service center. If it is determined at 70 that proof of age is required and proof of age has been tendered to the document reader, the vending machine utilizes artificial intelligence routines at 73 to: calculate a percentage probability that the buyer's photoidentification is valid at 73A, to calculate a percentage probability that the buyer is the person shown in the photoidentification at 73B, and to calculate a percentage probability that the buyer is sober at 73C. Artificial intelligence routines are discussed in previously incorporated U.S. Ser. No. 09/657,719. The vending machine then contacts the remote service center to alert a human operator that approval is required at 74 and provides the calculated probabilities thereto on the video display 40 (as indicated at 53, 54, 56 and 58 in FIG. 4). The transaction will be concluded under supervision of the remote human as indicated at 76 and described in further detail with reference to FIG. 6.

Referring now to FIG. 6, when an alert (or page) is detected at 80, one of the unoccupied human operators at the service center responds, and the video display 40 of the operator terminal 18 displays preferably all of the information shown in FIG. 4.

The operator determines the age indicated on the photoidentification at 82. The vending machine preferably reads the age from the photoidentification and displays the age at 53 (FIG. 4) for the convenience of the operator.

If the age on the photoidentification is above the legal age for the purchase, the operator determines whether the photoidentification is valid at 86. The operator uses a selected photoidentification sample (e.g,. sample 50 in FIG. 4) at 86a (matching the jurisdiction of the buyer's photoidentification), and visually compares the buyer's photoidentification with the sample at 86b. According to the presently preferred embodiment of the invention, the operator's work station is provided access to an image library containing images of valid photoidentifications, e.g., driver's licenses from various jurisdictions (e.g. the fifty states and the District of Columbia) and optionally international passports and/or other photoidentifications. The operator selects an image of a sample valid photoidentification from the same jurisdiction as the photoidentification presented by the buyer. The operator compares the photoidentification sample to the buyer's photoidentification at 86b to determine whether the buyer's photoidentification is genuine. For example, typeface and the placement of critical elements are examined. In addition, the operator is aided by a software calculated probability that the buyer's photoidentification is valid at 86c; i.e., the software searches for features such as holograms, watermarks, the absence of added adhesives or cut lines, etc., which indicate validity or invalidity of the identification.

The operator also determines at 88 whether it is the buyer who is pictured in the photoidentification presented by the buyer. The vending machine takes a video image of the buyer and transmits the image to the terminal 18 for comparison with the photoidentification. If the buyer is not looking into the video capture device, the operator can trigger a synthesized voice prompt asking the buyer to look at the camera; i.e., it appears to the buyer that the vending device, and not a human, is requesting the buyer to look at the camera. The operator compares the buyer's image to the photo image on the photoidentification at 88a and also uses a biometric analysis at 88b. The biometric analysis, using known biometric parameters, provides a percentage probability that the buyer is the same person in the photoidentification.

In addition, according to a preferred but optional step, the operator also determines, from the video image of the buyer and from the calculated probability provided by artificial intelligence routines, whether the buyer is sober at 90 prior to completing a purchase transaction for an alcoholic beverage. This can be done by visual examination at 90a, by software routine discriminators at 90b, and/or by tests of motor skills, response time, and/or visual acuity which are performed using the video and audio elements of the vending machine at 90c. For example, a potential purchaser of alcoholic beverages may be requested to touch one or more spots on a touch-sensitive display after a tone is heard. Either the vending machine or the human operator can determine whether a potential purchaser ‘passes’ the test.

If the operator concludes that the buyer is over the age required for the purchase at 82, has a valid photoidentification at 86, is the same person as pictured in the photoidentification at 88, and is sober 90, the operator authorizes the transaction at 92. It is recognized that the operator can perform any of the steps required to authorize the transaction in an order different from that described above.

If the photoidentification is determined to be genuine, the operator authorizes the transaction at 92 and optionally an audio/video message is provided by the vending machine indicating the purchase approval and thanking the buyer for the purchase. If any of the tests fail (age too young, counterfeit license, image mismatch, insobriety), the operator denies the transaction at 94, and an audio/video message is provided by the vending machine indicating the reason for denial of the purchase.

It is a desirable aspect of the invention that the participation of the remote human operator is completely invisible and inaudible to the buyer. From the buyer's perspective, the entire transaction is completed autonomously by the vending machine presumably using artificial intelligence. Thus, if it is necessary for the operator to communicate with the buyer, it is preferably done through synthesized speech or prerecorded phrases which sound like they are machine generated. The use of human operators at a centralized service center permits uniform training and testing of each operator prior to giving the operator authority to approve or deny transactions.

If the transaction is approved, it is preferable that a record of each transaction be maintained in a database, preferably in a computer at the service center. The record preferably includes pictures of the buyer and his or her photoidentification, pictures of the product vended, an electronic record of when and where the product was sold, and preferably a distinct identification number assigned to the transaction. The record serves multiple purposes. First, should an accusation be made that a product was vending to an underage individual, the record verifies the steps taken to ensure that the product was vended to an age-appropriate individual. Second, the record can be used to remotely indicate the product sold so that a vendor may refill product vended when supply is low. Third, the record provides valuable marketing data: the age of persons purchasing particular products, where particular products sell best, etc.

With the above vending machine system, appropriate, legal, and consistent sales of age-restricted items are accomplished using a device adapted to attract the attention of potential purchasers and engage the potential purchaser through completion of a vending transaction.

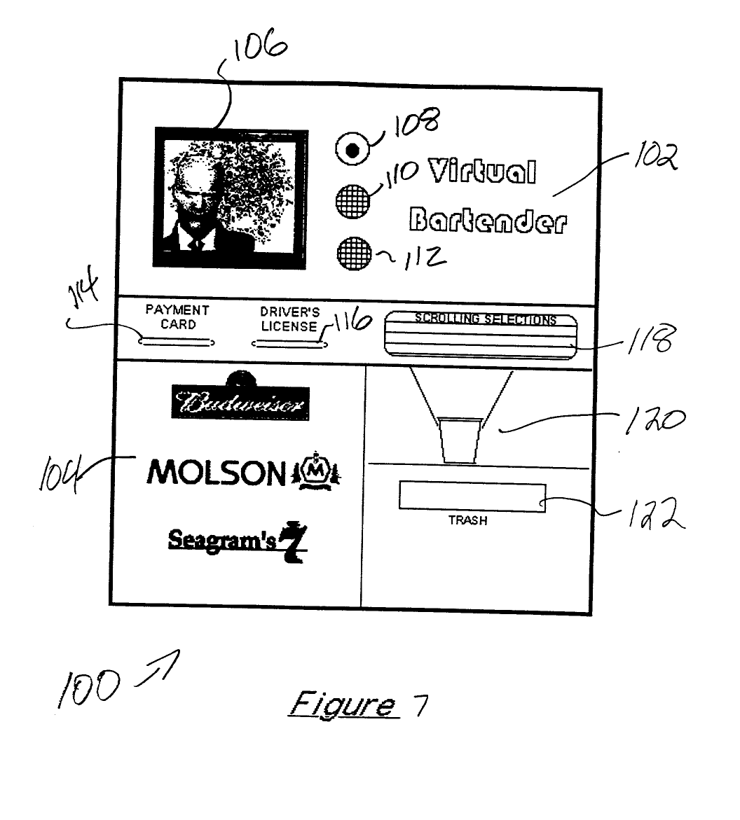

FIGS. 7-9 illustrate other exemplary vending machines according to the invention. FIG. 7 illustrates a “virtual bartender” machine 100. The machine preferably includes illuminated indicia 102 and advertising 104 which indicate to potential buyers what kind of beverages may be purchased from the machine. According to this embodiment, the machine 100 is also provided with a video display 106 for displaying a computer generated character, a video camera 108 for capturing an image of the buyer, a speaker 110 for playing the synthesized voice of the computer generated character, and a microphone 112 for voice recognition of the buyer. In addition, the machine 100 has a card payment slot 114, a driver's license slot 116, and a scrolling display of available beverage selections 118. As shown in FIG. 3, the dispensing portion 120 of the machine 100 include a cup dispenser similar to state of the art coffee and soft drink vending machines. A cup disposal 122 is provided to collect empty cups from buyers who finish their drink while near the machine. Although the advertising 104 suggests only beer and spirits, soft drinks may be vended from the same machine. The machine operates according to the procedures described above with reference to FIGS. 5 and 6. More particularly, the computer generated character in the display 106 may be programmed to look and act like a caricature of a stereotypical bartender. The audio played to accompany the character may also be programmed to say things stereotypical of a bartender, e.g. to tell jokes and/or act as a counselor in a manner similar to the famous “Eliza”, artificial intelligence simulation. The virtual bartender machine 100 may be placed in any suitable location. One advantageous application for the virtual bartender would be to place several throughout an airport, all coupled to the same network and controlled by a fewer number of human operators. It will be appreciated that in some applications ambient noise may prohibit voice recognition. In such applications, the microphone 112 may be omitted and one or more manual input devices supplied.

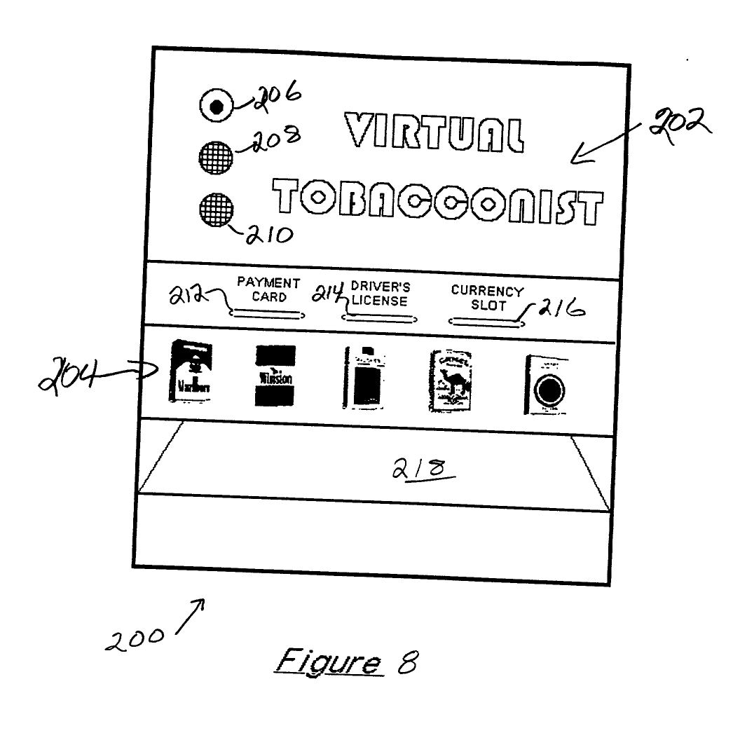

FIG. 8 illustrates a “virtual tobacconist” vending machine 200. The vending machine 200 preferably includes illuminated indicia 202, 204 which serve to identify what goods are available for purchase and act as advertising. This embodiment does not include a video display, but it does include a camera 206, a speaker 208, and a microphone 210. In addition to a payment card slot 212 and a driver's license slot 214, the machine 200 also includes a currency slot 216. The goods are delivered via the dispensing chute 218. It will be appreciated that the machine can be programmed to dispense individual packets of cigarettes or cartons of cigarettes or both according to the buyer's order. It will also be appreciated that if a transaction is canceled or not approved after currency has been placed in the currency slot, currency may be refunded via the dispensing chute 218.

It will be appreciated that features from the virtual tobacconist and the virtual bartender may be interchanged. The common feature of both of these machines and all of the vending machines according to the invention is that they present an interface to the buyer which appears to be completely non-human when, in reality, restricted transactions are secretly approved or denied by a remotely-located human operator.

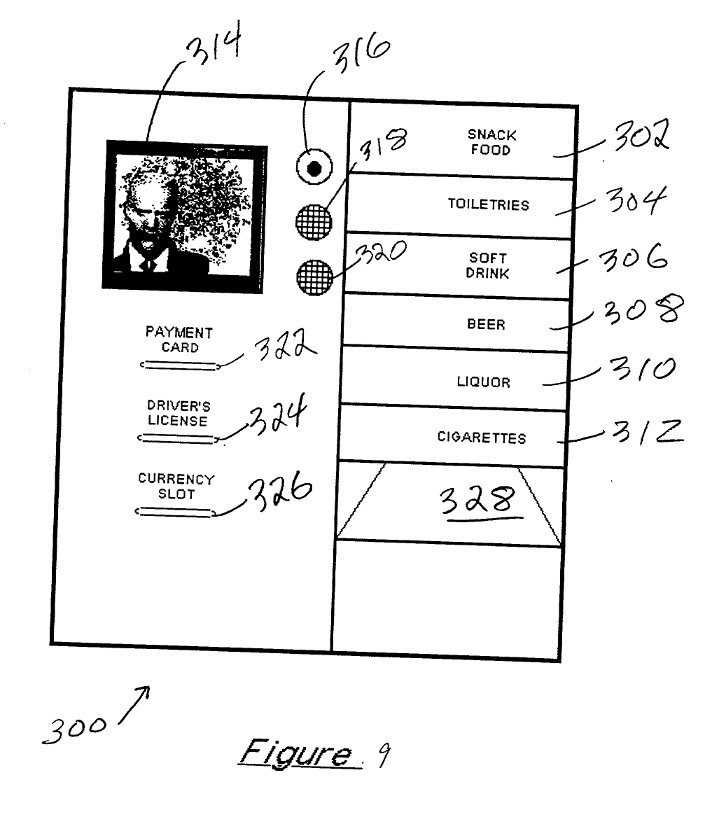

Vending machine 300 of FIG. 9 includes displays for a variety of products including snack food 302, toiletries 304, soft drinks 306, beer 308, liquor 310, and cigarettes 312; i.e., both non-age-restricted and age-restricted products. The machine also includes a video display 314, a camera 316, a speaker 318, and an optional microphone 320. Slots are provided for a payment card 322, a driver's license 324, and currency 326. Products are dispensed via the chute 328. The machine 300 operates in a manner as described above with reference to FIGS. 5 and 6. The displays 302-312 may be touch sensitive such that upon selecting one category of products, a menu of available products is displayed on the video display 314 or spoken in a synthesized voice through the speaker 318. As mentioned above with reference to FIG. 5, only some of the possible transactions will require identification and remote human intervention. This multipurpose vending machine is well suited for application in a small hotel or motel where shops for these products are not available.

There have been described and illustrated herein several embodiments of a vending machine adapted to vend age-restricted items. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. A vending machine for use with a remote service center which includes a humanly-operated control terminal which communicates with said vending machine to approve or deny vending certain transactions with a buyer, said vending machine comprising:
a) a video capture device for capturing an image of the buyer;
b) an identification document reader for capturing an image of an identification document of the buyer;
c) a communication link coupled to said video capture device and said identification document reader which transmits said image of the buyer and said image of the identification document to the humanly-operated control terminal; and
d) a user interface which gives the appearance to the buyer that said vending machine autonomously approves or denies the vending transactions.

2. A vending machine according to claim 1, wherein:
said user interface includes a video display.

3. A vending machine according to claim 2, wherein:
said user interface includes an animated character displayed on said video display.

4. A vending machine according to claim 3, wherein:
said animated character apparently autonomously interacts with the user.

5. A vending machine according to claim 1, wherein:
said user interface includes an audio reproducer.

6. A vending machine according to claim 5, wherein:
said user interface includes synthetic speech reproduced via said audio reproducer.

7. A vending machine according to claim 1, wherein:
some vending machine transactions are controlled by the humanly operated control terminal and some other vending machine transactions are completed without input from the humanly operated control terminal.

8. A vending machine according to claim 1, further comprising:
e) age-restricted items in said vending machine.

9. A vending machine according to claim 8, wherein:
said vending machine is adapted to vend an age-restricted item only after without receiving input from a remotely located human over a communications link.

10. A vending machine according to claim 1, further comprising:
e) means for conducting a sobriety test.

11. A vending machine according to claim 1, further comprising:
e) a processing system adapted to at least one of,
i) provide an indication of the validity of the identification document, and
ii) provide an indication of the likelihood that the buyer is a person whose image is located on the identification document.

12. A system for vending goods which require verifying the age and identity of a buyer of the goods, said system comprising:
a) a remotely-located service center which includes a humanly operated control terminal; and
b) a vending machine, including
i) a video capture device for capturing an image of a buyer,
ii) an identification document reader for capturing an image of an identification document of the buyer,
iii) a communication link coupled to said video capture device and said identification document reader for transmitting said image of the buyer and said image of the identification document to said humanly operated control terminal, and
iv) a user interface which gives the appearance to the buyer that the vending machine processing a vending transaction autonomously.

13. A system according to claim 12, wherein:
said user interface includes a video display.

14. A system according to claim 13, wherein:
said user interface includes a computer generated character displayed on said video display.

15. A system according to claim 12, wherein:
said user interface includes an audio reproducer.

16. A system according to claim 15, wherein:
said user interface includes synthetic speech reproduced via said audio reproducer.

17. A system according to claim 12, wherein:
some vending machine transactions are controlled by the humanly operated control terminal and some other vending machine transactions are completed autonomously.

18. A system according to claim 12, further comprising:
a database in which information related to the identification document and an item vended is recorded.

19. A system according to claim 12, further comprising:
c) a processing system adapted to at least one of,
i) provide an indication of the validity of the identification document, and
ii) provide an indication of the likelihood that the buyer is a person whose image is located on the identification document.

20. A method of vending age-restricted products from a vending machine, comprising:
a) providing a vending machine which appears to a potential purchaser to function autonomously, the vending machine provided with age-restricted product;
b) at the vending machine taking an image of a potential purchaser of an age-restricted product;
c) at the vending machine taking an image of a photoidentification of the potential purchaser;
d) transmitting the images to a remotely located human;
e) determining by the human the validity of the photoidentification;
f) determining by the human whether the image of the potential purchaser matches a photo image on the photoidentification;
g) if it is determined that the photoidentification is valid and the image of the potential purchaser matches the photo image, then vending the age-restricted product; and
h) if it is determined that the at least one of (i) the photoidentification is invalid and (ii) the image of the potential purchaser mismatches the photo image, then denying the potential purchaser from purchasing the age-restricted product at the vending machine.

21. A method according to claim 20, further comprising:
i) prior to determining by the human the validity of the photoidentification, providing the human a computer-calculated likelihood that photoidentification is valid; and
j) prior to determining by the human whether the image of the potential purchaser matches a photo image on the photoidentification, providing the human a computer-calculated likelihood that the image of the potential purchaser matches the photo image on the photoidentification.

22. A method according to claim 20, further comprising:
i) recording in a database data relating to the photoidentification and the vended product.

23. A method according to claim 20, further comprising:
i) using the vending machine to perform a sobriety test prior to vending an age-restricted product, the age-restricted product being an alcoholic beverage.

24. A method according to claim 20, further comprising:
i) using an animated character on a video display on the vending machine to interact with the potential purchaser during the transaction.

25. A method according to claim 20, wherein:
the vending machine appears to approve or deny vending transactions autonomously.
